(19) United States
(12) Patent Application Publication
(10) Pub. No.: US 2001/0029560 A1
(43) Pub. Date: Oct. 11, 2001

(54) Computer farm with a system for the hot insertion/extraction of processor cards

(76) Inventor: Hugo Delchini, Paris (FR)

Correspondence Address: Robert W. Bergstrom, Summit Law Group PLLC, Suite 300, 1505 Westlake Ave. N., Seattle, WA, 98109, US

(21) Appl. No.: 09/728,362

(22) Filed: Nov. 30, 2000

(30) Foreign Application Priority Data
Apr. 5, 2000 (FR) FR0004361

(51) Int. Cl. G06F 13/00

(52) U.S. Cl. 710/103

(57) ABSTRACT

The invention relates to a computer farm, comprising a bus (7) and several processor cards (3a-3h) mounted on the bus, an address of a memory area, so-called state area (8), being predefined for each location of the bus which may receive a processor card.

The farm comprises a means of periodic monitoring of all the state areas (8) situated at the predefined addresses, this means of monitoring having as function to trigger a particular computing process of the processor card which is situated at the corresponding location, and each processor card includes an automatic means of writing a particular value to the state area situated at the predefined address corresponding to its location on the bus, which means is triggered upon the occurrence of an event relating to the powering-up of the card, to its resetting or to its extraction from the farm.

The present invention relates to a computer farm with a system for the hot insertion/extraction of processor cards.

Computer clusters are known, these being computer-based infrastructures consisting of a large number of computers operating simultaneously and exchanging data with one another.

These clusters are for example used to offer Internet access to individuals.

One of the problems which arise with clusters is their footprint, and this is why the solution consisting in gathering together within one and the same box several computers linked by a bus has already been proposed.

One then speaks of a farm of computers.

Although the computer farms proposed hitherto do actually make it possible to reduce the amount of space occupied by the cluster, owing to the fact that a single farm replaces six or eight independent computers, the maintenance of the computer cluster is nevertheless complex since each computer must be administered and maintained individually.

Within a computer farm, the maintenance and administration operations may even prove to be more complex than for independent computers, since the replacing of a single computer of the farm requires particular manipulations, so as not to disturb the operation of the other computers of the same farm.

The present invention aims to provide a novel computer farm whose administration and maintenance are greatly eased.

The subject of the present invention is a computer farm, comprising a bus and several processor cards mounted on the bus, an address of a memory area, so-called state area, being predefined for each location of the bus which may receive a processor card, which farm comprises a means of periodic monitoring of all the state areas situated at the predefined addresses, via bus reading cycles, this means of monitoring having as function, when it detects a particular value in one of said areas, to trigger a particular computing process, defined by this particular value, of the processor card which is situated at the corresponding location, wherein each processor card includes an automatic means of writing a particular value to the state area situated at the predefined address corresponding to its location on the bus, which means is triggered upon the occurrence of an event relating to the powering-up of the card, to its resetting or to its extraction from the farm.

Stated otherwise, the farm according to the invention comprises an automatic means for managing the insertion and extraction of the processor cards which each constitute an individual computer of the farm.

Thus, by virtue of the invention, it is no longer necessary for the operator who wishes to replace a defective computer of the cluster to intervene in the operation of said cluster in order to reboot the replacement computer and have it incorporated in the cluster.

The insertion and the extraction of the processor cards can thus be performed “hot”, that is to say without interrupting the operation of the cluster.

In a particular embodiment of the invention, the farm includes a means for simulating a local network between the processor cards mounted on the bus. The computers of the farm exchange data with one another in the same way as if they were linked by a local network.

In a first embodiment of the invention, the particular process is a process for starting programs required to execute on the card and the particular value is “initialization request”, the automatic means for writing this value being triggered when the card is powered up or reset.

The card is powered up when the computer farm is switched on or when the card is inserted into the farm.

In a second embodiment of the invention, each processor includes a means allowing a user to request the shutdown of the card and the particular process is a process for shutting down programs executing on the card, the particular value being “shutdown request”, the automatic means for writing this value being triggered as soon as the user requests the shutdown of the card.

For its insertion and extraction, each card can comprise locking tabs in its housing, which tabs can be maneuvered between an open position and a closed position, and at least one sensor able to detect the open position of at least one of said tabs. In this case, the means allowing the user to request the shutdown of the card consists of said tabs.

When the users shifts the tabs into the open position so as to extract the card, the sensor detects this change of position of the tabs and the automatic means of writing writes the value “shutdown request” to the state area, thereby causing the execution of the process for shutting down the programs executing on the card. After this, the card can be physically extracted from the farm.

Likewise, when the card is inserted into the farm, its powering-up causes the writing, by the automatic means of writing, of the value “initialization request” to the state area of the card and the process for starting the programs requiring to be executed on the card is initiated.

In a particular embodiment, the automatic means for writing included in the card is a program stored in a nonvolatile memory, for example a Read Only Memory mounted on the card.

In the processor cards commonly used, the link between the bus and the card is effected with the aid of a bridge, which bridge includes a certain number of registers making it possible to establish the communication. In a particular embodiment using such cards, the state area is a register belonging to the bridge serving to link the card physically to the bus.

The state register can also be present on the card elsewhere than in the bridge. The state register could also be sited anywhere else in the farm, and not necessarily on the card.

In a particular embodiment, the means of periodic reading is a program which is executed on one of the processor cards.

The processor card hosting this program can for example be a particular card, referred to as “controller card”, on which are executed a certain number of programs related to the simulation of the network on the bus as well as to the monitoring of the various processor cards linked by the bus.

In a particular embodiment of the invention, the process for starting the card consists of the following steps:

downloading an operating system into the memory of the card,

remotely starting the operating system on the card,

writing the value “start” to the state area situated at the predefined address corresponding to the location of the card on the bus.

Thus, the state area serves not only to cause the starting of the card but also to indicate to a mechanism for monitoring the cards that the starting of the card has been performed correctly.

To implement the startup process just described, one may proceed in the following manner.

Each card comprises, stored in a nonvolatile memory, on the one hand a limited number of basic functions, on the other hand a remote execution module, which continuously scans a predefined parameter memory area of the card and, when it detects a value written to the parameter memory area, triggers the execution of the function identified by the written value, then writes, to the parameter memory area, a value signifying that execution of the function is completed.

Among the basic functions stored in the nonvolatile memory of the card is a function for starting the operating system after downloading the latter.

In an advantageous variant of this embodiment, the value signifying that execution of the function is completed is the value “start”, in the case of successful starting, or an indication of an intermediate state in the case of partial failure, depending on the stage at which startup failed.

In a particular embodiment, the farm includes a means for preparing, before starting the operating system, a disk intended to be used as main disk by this operating system.

In a particular embodiment, the shutdown process consists of the following steps:

shutting down of the operating system in the memory of the card,

writing of the value “idle” to the state area situated at the predefined address corresponding to the location of the card on the bus.

As described previously for the starting of a card, the process for switching off the card can be triggered by execution of one of the basic functions stored in the nonvolatile memory of the card.

The computer farm according to the invention can in particular be constructed around a bus of PCI or CompactPCI type on which a network of Ethernet type is simulated.

With the aim of providing a clearer understanding of the invention, an embodiment thereof given by way of a nonlimiting example will now be described with reference to the appended drawing in which:

FIG. 1 is a three-quarter perspective front view of a computer farm according to the invention;

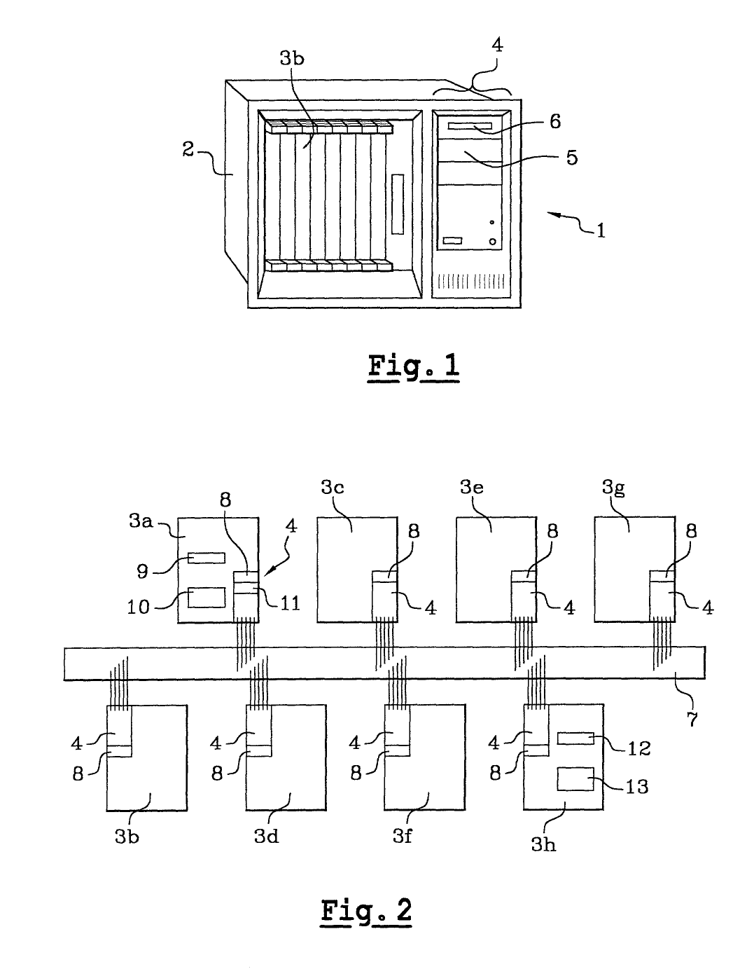

FIG. 2 is a diagrammatic view of a bus and of an assembly of processor cards mounted on this bus,

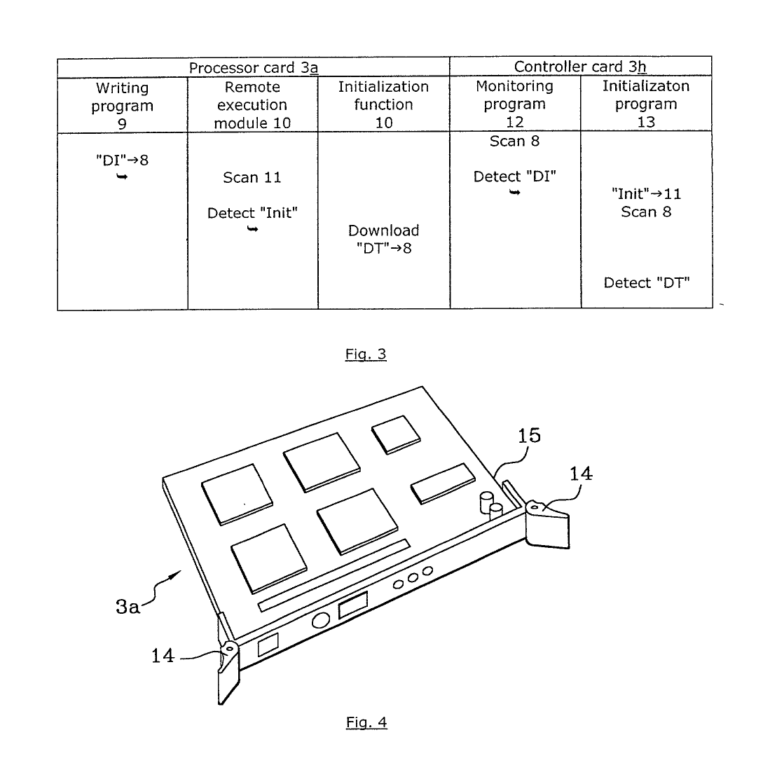

FIG. 3 is a chart illustrating the operations executed when inserting the card into the bus,

FIG. 4 is a perspective view of a processor card.

The farm 1 represented in the drawing comprises a box 2 which accommodates a bus (not visible in this figure) on which are mounted eight processor cards 3a-3h.

The farm comprises a compartment 4 containing a supply assembly and mass memories consisting in particular of a hard disk 5, as well as a CD ROM drive 6.

The bus 7 is diagrammatically represented in FIG. 2, in which it may be seen that the processor cards 3a-3h communicate with the bus by way of bridges 4, the data exchanges between the processor cards 3a-3h being performed by read and write cycles on the bus 7.

Each bridge 4 contains registers, just one of which is represented here and will be referred to as the state register 8 in the subsequent description.

In the example described, the card 3h plays the role of controller card. It monitors the state of the other cards and undertakes the management of the farm, in particular on the occurrence of an event relating to the powering-up of any one of the other cards, to its resetting or to its extraction from the farm.

For the clarity of the drawing, only the details of the card 3a and of the controller card 3h will be described. The other cards 3b to 3g are identical to the card 3a, at least as regards the characteristics which will be described. The cards 3a to 3g may nevertheless be distinguished through other characteristics unconnected with the present invention.

The card 3a includes, on the one hand, a nonvolatile memory 9, for example a read only memory (ROM), containing a program for writing a value “initialization request” (DI) or “shutdown request” (DA) to the state register 8. This program starts automatically when the card is powered up.

Furthermore, the card 3a includes another nonvolatile memory 10, which could be part of the ROM 9, containing a series of preprogrammed functions and a remote execution module.

The preprogrammed functions are basic functions whose execution serves in the administration and the testing of the operation of the card. One of these functions carries out the initialization of the card, as will be described.

The remote execution module has the role of triggering the execution of one of the basic functions, upon an instruction given by the controller card 3h.

To this end, another register 11 of the bridge, referred to as the parameter register, is used, as will be described later.

The controller card 3h contains a program 12 for monitoring the state registers 8 of all the other cards 3a to 3g, as well as a program 13 for initializing or shutting down said other cards.

With reference to FIG. 3, the operation of the farm will now be described in the case of the insertion or extraction of a card.

The monitoring program 12 of the controller card 3h continuously scans the state register 8 of each card 3a to 3g.

The processor card 3a is inserted into its location on the bus, thereby causing its power-up and the automatic starting of the program stored in the ROM 9 for writing the value “DI” (initialization request) to the state register 8.

Immediately afterwards, the remote execution module starts on the processor card and scans the parameter register 11.

The monitoring program 12 detects the value “DI” and triggers execution of the initialization program on the controller card.

The latter program writes the value “Init” to the parameter register 11,

and scans the state register 8 of the card.

The remote execution module on the processor card 3a detects the value “Init” in the parameter register 11 and triggers the execution of the initialization function, whose code is stored in the memory 10.

The latter downloads and starts the operating system in the processor card, via the bus, and writes the value “DT” (startup terminated) to the state register 8.

The initialization program on the controller card detects the value “DT”, thereby indicating that the card has been correctly started. The initialization program terminates whilst the monitoring program continues to scan all the state registers 8 of all the cards 3a to 3g.

The initialization of any processor card which is inserted into a location of the bus is thus performed automatically, without any operator having to intervene.

The same automatic procedure runs when the card is powered up, for example when the computer farm is switched on, where all the processor cards must be initialized even though they are already inserted into their locations.

If a card must be extracted, for example because an operator has discerned a malfunctioning of the latter, the following steps are executed.

These steps will be described by analogy with processes for starting the card.

The operator requests the shutdown of the card, using a specific means provided for this purpose, for example rocking tabs 14 allowing the card to be locked into its location, as described in FIG. 4.

The writing program writes the value “DA” (shutdown request) to the state register 8.

The monitoring program of the controller card detects this value and initiates a shutdown program, the counterpart of the initialization program.

If currently-executing software is distributed among all the computers of the farm, certain specific operations may be necessary in order for this software to allow for the fact that the processor card will be rendered unavailable. The shutdown program begins by executing these specific operations, which form an integral part of the software but had been declared, during their installation in the farm, to be parts that have to be executed in case of the shutdown of a card.

The shutdown program then writes the value “Shutdown” to the parameter register 11 of the card.

The remote execution module detects this value and starts a Shutdown function included in the basic functions of the memory 10.

The Shutdown function shuts down the operating system on the card and writes the value “Idle” to the state register 8.

The shutdown program detects the value “Idle”.

Thus, the farm allows fully for the shutdown of the card, the operator merely having to request the shutdown.

This shutdown request can be performed by maneuvering locking tabs 14 of the card, as may be seen in FIG. 4. One of these tabs includes a sensor 15 formed by an interrupt switch whose state is continuously scanned by a monitoring loop executing on the card.

Such tabs are already known in themselves.

The above embodiment is merely one example given for a clear understanding of the invention, which is in no way limited to the characteristics described with reference to this example.

1. A computer farm, comprising a bus (7) and several processor cards (3a-3h) mounted on the bus, an address of a memory area, so-called state area (8), being predefined for each location of the bus which may receive a processor card,
which farm comprises a means of periodic monitoring of all the state areas (8) situated at the predefined addresses, via bus reading cycles, this means of monitoring having as function, when it detects a particular value (“DI”, “DA”) in one of said areas, to trigger a particular computing process, defined by this particular value, of the processor card which is situated at the corresponding location,
and wherein each processor card includes an automatic means of writing a particular value (“DI”, “DA”) to the state area situated at the predefined address corresponding to its location on the bus, which means is triggered upon the occurrence of an event relating to the powering-up of the card, to its resetting or to its extraction from the farm.

2. The computer farm as claimed in claim 1, which farm includes a means for simulating a local network between the processor cards (3a-3h) mounted on the bus (7).

3. The computer farm as claimed in either one of claims 1 and 2, wherein:
the particular process is a process for starting programs required to execute on the card and
the particular value is “initialization request” (“DI”),
the automatic means for writing this value is triggered when the card is powered up or reset.

4. The computer farm as claimed in claim 3, wherein the card is powered up when the computer farm is switched on or when the card is inserted into the farm.

5. The computer farm as claimed in any one of claims 1 to 4, wherein each processor card includes a means (14) allowing a user to request the shutdown of the card and wherein
the particular process is a process for shutting down programs executing on the card and
the particular value is “shutdown request” (“DA”),
the automatic means for writing this value is triggered as soon as the user requests the shutdown of the card.

6. The computer farm as claimed in claim 5, wherein each card comprises locking tabs (14) in its housing, which tabs can be maneuvered between an open position and a closed position, and at least one sensor (15) able to detect the open position of at least one of said tabs, and wherein the means allowing the user to request the shutdown of the card consists of said tabs.

7. The computer farm as claimed in any one of claims 1 to 6, wherein the automatic means for writing included in the card is a program stored in a nonvolatile memory (9), for example a Read Only Memory mounted on the card.

8. The computer farm as claimed in any one of claims 1 to 7, wherein the state area is a state register (8) present on the card.

9. The computer farm as claimed in claim 8, wherein the state register (8) belongs to a bridge (4) serving to link the card physically to the bus.

10. The computer farm as claimed in any one of claims 1 to 9, wherein the means of periodic reading is a program which is executed on one of the processor cards.

11. The computer farm as claimed in claim 3 and any one of claims 4 and 7 to 10, wherein the process for starting the card consists of the following steps:
downloading an operating system into the memory of the card,
remotely starting the operating system on the card,
writing the value “started” (“DT”) to the state area (8) situated at the predefined address corresponding to the location of the card on the bus.

12. The computer farm as claimed in any one of claims 1 to 11, wherein each card comprises, stored in a nonvolatile memory (10), on the one hand a limited number of basic functions, on the other hand a remote execution module, which continuously scans a predefined parameter memory area (11) of the card and, when it detects a value written to the parameter memory area, triggers the execution of the function identified by the written value, then writes, to the parameter memory area, a value (“DT”) signifying that execution of the function is completed.

13. The computer farm as claimed in claims 11 and 12, wherein the starting of the downloaded operating system is triggered by execution of one of the basic functions.

14. The computer farm as claimed in any one of claims 11 to 13, wherein the value written to the memory area after starting the operating system is the value “started” in the case of successful starting, or an indication of an intermediate state in the case of partial failure, depending on the stage at which startup failed.

15. The computer farm as claimed in any one of claims 11 to 14, which farm includes a means for preparing, before starting the operating system, a disk intended to be used as main disk by this operating system.

16. The computer farm as claimed in any one of claims 11 to 15, which farm includes a wait limiter which reruns the steps for starting the card if the value “started” does not appear in the state memory area after a predefined period.

17. The computer farm as claimed in claim 4 and any one of claims 5 to 10, wherein the shutdown process consists of the following steps:
shutting down of the operating system in the memory of the card,
writing of the value “idle” to the state area (8) situated at the predefined address corresponding to the location of the card on the bus.

18. The computer farm as claimed in claims 17 and 12, wherein the turning-off of the card is triggered by execution of one of the basic functions.

19. The computer farm as claimed in any one of claims 1 to 18, wherein the bus is of PCI or CompactPCI type.

20. The computer farm as claimed in any one of claims 1 to 19, wherein the simulated local network is an Ethernet network
